(19) United States
(12) Patent Application Publication
(10) Pub. No.: US 2007/0091119 A1
(43) Pub. Date: Apr. 26, 2007

(54) Integrated massing and design CAD models

(76) Inventors: Matthew Jezyk, Medford, MA (US); Lev Lipkin, Weston, MA (US)

Correspondence Address: FISH & RICHARDSON P.C., PO BOX 1022, MINNEAPOLIS, MN, 55440-1022, US

(21) Appl. No.: 11/341,228

(22) Filed: Jan. 26, 2006

Related U.S. Application Data
(60) Provisional application No. 60/729,845, filed on Oct. 24, 2005.

(51) Int. Cl. G09G 5/00

(52) U.S. Cl. 345/619

(57) ABSTRACT

Systems and techniques to provide for software installation. In general, in one implementation, the technique includes providing a first model, the first model being one of: a massing computer aided design (CAD) model or a detailed CAD model; providing a second model, the second model being an other one of: the massing CAD model or the detailed CAD model; and creating a first object in the first model based on a feature of a second object in the second model.

### CROSS REFERENCE TO RELATED APPLICATION

This application claims priority to pending U.S. Provisional Application Ser. No. 60/729,845, entitled “Integrated Massing and Design CAD Models”, filed on Oct. 24, 2005, the entire contents of which are hereby incorporated by reference.

### BACKGROUND

In the development of architectural designs, architects often do massing studies, in which they experiment with different designs by assembling simple geometric forms of a building or a building complex. Massing studies allow architects to view the interaction of various building forms, perform sun studies, and try out various design configurations. After a massing study is approved, a detailed architectural design which can be used to construct the building or building complex is created. However, information developed in the massing study may be required to be recreated in the detailed design, resulting in duplicated effort and introduction of errors. Moreover, additional massing studies may be required while the detailed design is in development. Substantial changes between new massing studies and the detailed design can cause significant rework of the detailed design resulting in additional effort and/or delays in the production of the final construction drawings.

### SUMMARY

This disclosure generally describes systems, methods and computer programs for integrating massing and detailed design computer-aided design (CAD) models.

In one aspect, a massing CAD model is provided. A user input is received, the user input selects a feature of a mass object in the massing CAD model. A detailed object is created in a detailed CAD model, the detailed object is based on the selected feature.

Implementations may include one or more of the following characteristics. Providing the massing CAD model includes receiving user input creating the massing CAD model. Providing the massing CAD model includes importing the massing CAD model. Providing an interactive view of one or more of the massing CAD model or the detailed CAD model. The detailed object is one of: a curtain system, a wall, a floor, or a roof, or a building construction element. The mass object is a geometric form of a building or a geometric form of a portion of a building. The massing CAD model and the detailed CAD model are versions of a common CAD model. The selected feature is a surface on a mass object. User input designates a detailed object type. Creating the detailed object includes creating a surface on the detailed object that is equivalent to, or proportional to, a surface on the mass object. Creating the detailed object includes creating the detailed object at a location in the detailed model that corresponds to a location in the massing model. Modifying geometry of the selected mass object is based on user input. The geometry of the detailed object is updated to reflect the modifying of the selected mass object.

In another aspect, a massing CAD model is provided. A user input selecting a mass object in the massing CAD model is received. A detailed object is created in a detailed CAD model, the detailed object is based on the selected mass object. An association is created between the detailed object and the selected mass object such that changes to the mass object can be propagated to the detailed object.

Implementations may include one or more of the following characteristics. Creating an association includes associating a surface on the selected mass object with the detailed object. The geometry of the selected mass object is modified based on user input and updating geometry of the detailed object to reflect the modifying of the selected mass object. Updating the geometry of the detailed object includes conforming the geometry of a detailed object to a modified surface of a selected mass object. The geometry of a detailed object is modified based on user input. The geometry of the selected mass object is updated to reflect the modifying of the detailed object. Updating geometry of the selected mass object includes conforming geometry of a surface on the selected mass object to geometry of the detailed object.

In another aspect, a feature of a mass object is selected in a massing CAD model. A detailed object is created in a detailed CAD model. The detailed object is based on the selected feature.

Implementations may include one or more of the following characteristics. The feature is a surface on the mass object. Creating a detailed object creates an association between the feature and the detailed object such that changes to the feature can be propagated to the detailed object. The massing CAD model is a massing study of a building. The detailed CAD model is a building design.

In another aspect, an association is created between a feature of a mass object in a massing CAD model and a detailed object in a detailed CAD model. Modification of a feature of the mass object is detected. The detailed object is identified based on the association. The detailed object is updated to reflect the modification of the feature.

Implementations may include one or more of the following characteristics. The feature is a surface. Updating the detailed object includes incorporating the geometry of the surface into the detailed object. Determining whether updating the detailed object would create a conflict. Resolving the conflict. Detecting modification of the detailed object. Identifying the mass object based on the association. And updating the mass object to reflect the modification of the detailed object.

In another aspect, a first model is provided, the first model being one of: a massing CAD model or a detailed CAD model. A second model is provided, the second model being an other one of: the massing CAD model or the detailed CAD model. A first object is created in the first model based on a feature of the a second object in the second model.

Implementations may include one or more of the following characteristics. Providing the first model includes receiving user input creating the first model. Providing the second model includes receiving user input creating the second model. Providing the first model includes importing the first model. Providing the second model includes importing the second model. An object is one of: a mass object, a curtain system, a wall, a floor, or a roof, or a building construction element. A mass object is a geometric form of a building or a geometric form of a portion of a building. The massing CAD model and the detailed CAD model are versions of a common CAD model. Creating the first object includes creating a surface on the first object that is equivalent to, or proportional to, a surface on the second object. Creating the first object includes creating the first object at a location in the first model that corresponds to a location in the second model. The first object and the second object have one or more equivalent surface geometries.

Implementations of the invention can realize one or more of the following advantages. A better workflow is created for architects and building designers. Information is entered once and then reused. As a result, the detailed design model can be developed in parallel with the massing model. Information developed in either model can be used to automatically create objects in the other. Faces of mass objects (sides, top, bottom), can be selected to create walls, roofs, floors and curtain systems in the detailed model such that the objects created thusly have corresponding geometry and position to the faces. Changes to design objects can be automatically reflected in mass objects. An increase in the number of floors in the detailed model, for example, can enlarge a massing object. Changes in the geometry of faces can be automatically replicated to detailed objects in the detailed model and vice versa. And changes in one view of a model can be reflected in other views of the model. The massing and detailed design models can be embodied in the same model. The model can be persisted in a single file. All deliverables can be generated from the single model.

The details of one or more implementations of the invention are set forth in the accompanying drawings and the description below. Other features, objects, and advantages of the invention will be apparent from the description and drawings, and from the claims.

### DESCRIPTION OF DRAWINGS

FIG. 1 is screen shot of a graphical user interface as presented by an interactive CAD tool.

FIG. 2 is screen shot of the GUI after an exterior wall has been automatically generated based on selected faces in the massing model.

FIG. 3 is screen shot of the GUI illustrating a newly created detailed object in the massing model and the detailed model.

FIG. 4 is a screen shot of the GUI after the shape of a mass object has been changed.

FIG. 5 is a screen shot of the GUI showing a wall after being updated with a face's new geometry.

FIG. 6 is a screen shot of the GUI showing both the massing model and the detailed model after additional detailed objects are added to the detailed model.

FIG. 7 is a diagram illustrating a system.

FIG. 8 is a flow diagram illustrating creation of a detailed object from a feature of a mass object.

FIG. 9 is a flow diagram illustrating creation of an association between objects.

FIG. 10 is a flow diagram illustrating change propagation.

FIG. 11 is a flow diagram illustrating automatic conversion of a model.

Like reference symbols in the various drawings indicate like elements.

### DETAILED DESCRIPTION

A system and methods for integrating massing and detailed design CAD models are described.

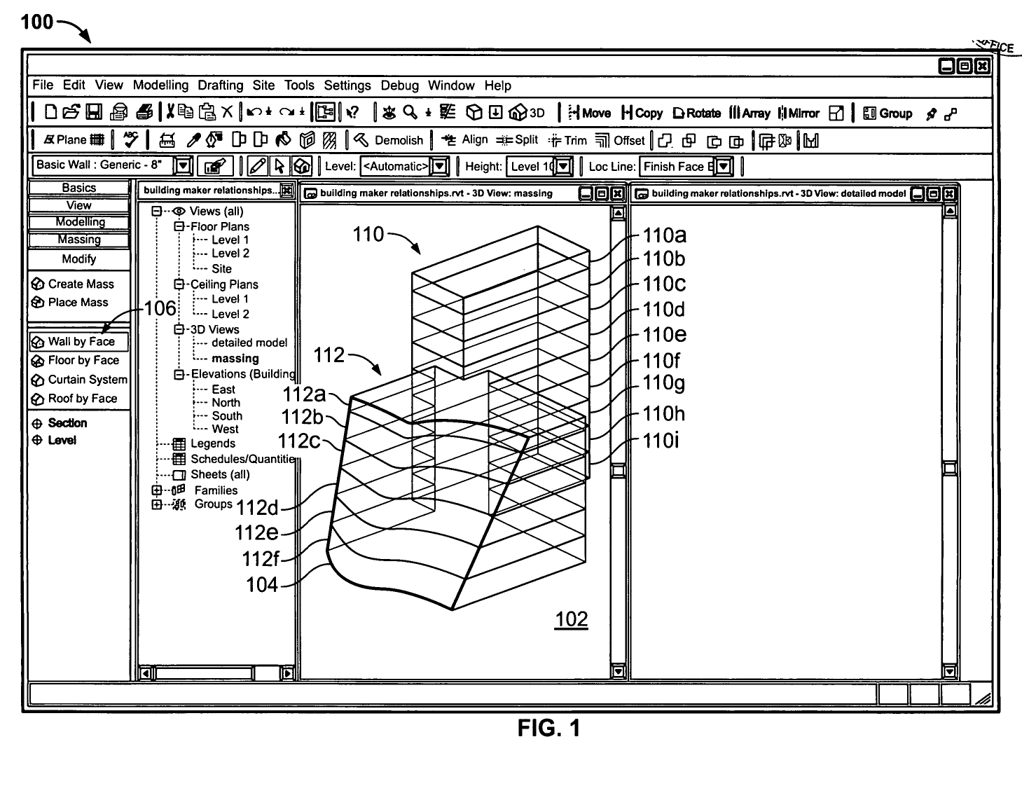

FIG. 1 is screen shot of a graphical user interface (GUI) 100 as presented by an interactive CAD tool. The CAD tool allows for creating, viewing and modifying of models. In one implementation, the tool is Autodesk® Revit® Building, available from Autodesk, Inc. of San Rafael, Calif. Generally speaking, a model can be a CAD model or a view of one or more CAD models. Although a GUI is illustrated, other user interfaces can be used in systems and methods for interacting with and modifying CAD models, including user interfaces that allow for user interaction by means of sound, voice, gesture, eye movement and/or use of remote control devices. The user interface can be provided on a number of devices including, but not limited to, devices such as a workstations, personal computers, cellular telephones, personal digital assistants, portable video playback devices, combinations thereof, and other suitable devices.

By way of illustration, a view of a massing model is presented in GUI region 102. The massing model can be used to create massing studies of buildings, building complexes or other structures. The massing model can be created by a user or can be imported from another tool. The massing model includes mass objects (110 and 112) representing forms. Mass objects can be three-dimensional (3D), as shown here, but can also be two-dimensional (2D). Mass objects can be rendered as opaque to provide an overall feel of how a completed project might appear. The objects can also be rendered in a transparent fashion to reveal objects, interferences and interfacing between object surfaces that would be hidden in an opaque rendering.

Mass objects can be combined to create larger volumes or subdivided to create smaller volumes. In one implementation, if two mass objects intersect (e.g., 110 and 112) they can be combined. The combination can be the addition of two masses to form a larger solid. Or, one mass can be subtracted from the other to form holes or “cut-outs” in the other. Mass objects can also be subdivided or “sliced” to create smaller mass objects. In this illustration, mass object 110 has been subdivided a number of times to create mass objects 110a, 110b, 110c, 110d, 110f, 110g, 110h and 110i. Likewise, mass object 112 has been subdivided into mass objects 112a, 112b, 112c, 112d, 112e and 112f. Subdividing mass objects can be useful for creating floors in a detailed model (see below). In one implementation, a mass object can be “sliced” with a surface (e.g., a two-dimensional manifold).

A detailed architectural design or detailed model provides construction elements such as (but not limited to) walls, floors, roofs and window curtain systems that can be used to construct a building, building complex, or other structure that conforms to the massing model. Although the massing model and the detailed model are treated as separate for discussion purposes, in one implementation both models are different views of a common underlying model. A detailed model is traditionally not undertaken until the massing model is complete. This is typically done to control costs and reduce errors in creating the detailed model. However, if the massing model is changed after the detailed model is created, the detailed model must be manually recreated which takes time and can introduce errors. Besides eliminating such errors, the approach described in this disclosure allows an architect or other designer to begin to work on the detailed model before the massing model is finalized, and keeps both models synchronized as they change.

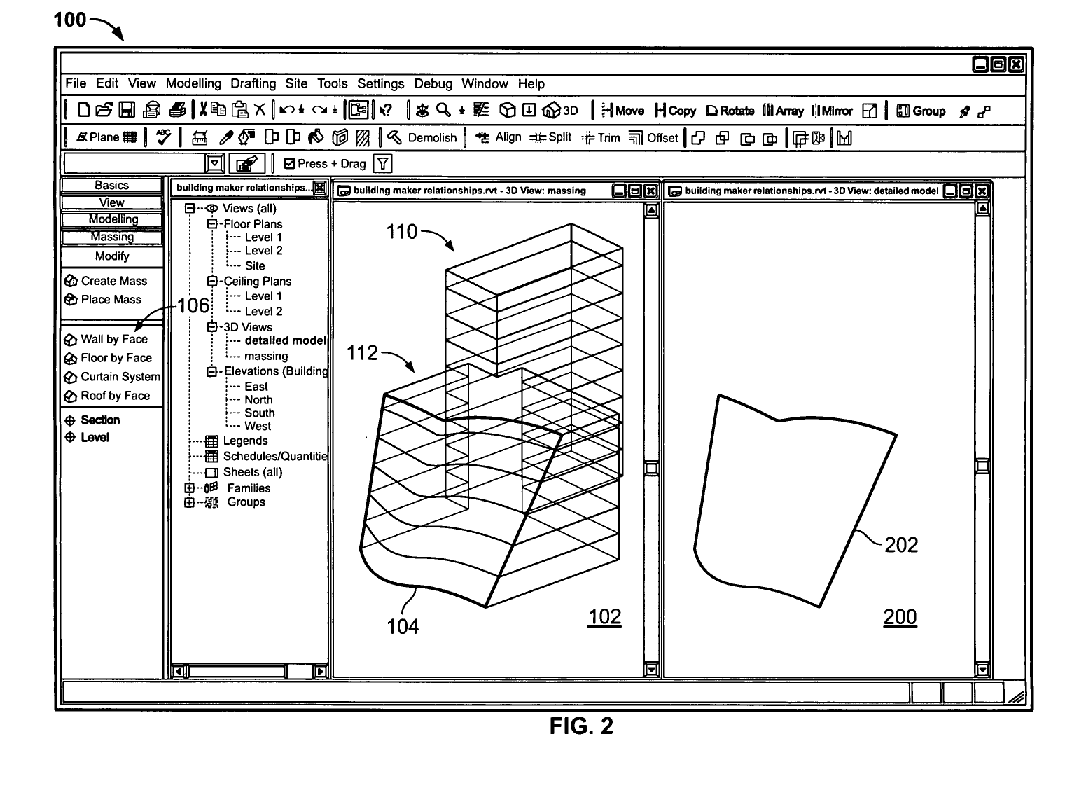

In one implementation, a detailed object (e.g., an interior or exterior wall, a floor, a roof, a curtain system, or any other suitable construction element) in a detailed model can be created based on one or more mass object surfaces or faces. Referring again to FIG. 1, face 104 of mass object 112 has been selected as indicated by an outline surrounding the face 104. A single detailed object can be automatically created in the detailed model based the selected face 104, as is shown in FIG. 2. A single detailed object can also be created based on a plurality of selected faces. A separate detailed object can be created in the detailed model for each selected face. Moreover, multiple detailed objects can be created in the detailed model based on a single face. In this illustration, the user can chose to create a wall with the face 104 by selecting a “Wall by Face” button on the GUI 100. This will cause a wall to be automatically created in a detailed model having a geometry conforming to the selected faces. See FIG. 2.

FIG. 2 is screen shot of the GUI 100 after an exterior wall 202 has been automatically generated based on the selected face 104 in the massing model. In this illustration, the wall 202 conforms to the geometry of the faces 104 and is visible in a detailed model (a view of which is shown in GUI region 200) and is placed at a location that corresponds to the faces 104 in the massing model. In one implementation, a detailed object created based on one or more faces has at least one surface that has the same or similar geometry as the face(s). For example, a wall detailed object has a surface that has the same geometry as the face(s) on which it is based. In another implementation, a detailed object created from one or more faces has at least one surface that is related proportionally to the face(s). For example, a floor detailed object may be set back an equal distance from interior walls, even though it has the same general shape as the face representing the floor (i.e., the slice) on which it is based. In yet a further implementation, an automatically created detailed object's geometry is determined by rules or attributes associated with the system or the detailed object.

In one implementation, a mass object in a massing model can be created based on one or more detailed object faces. Referring again to FIG. 2, mass object 112 can be automatically created in the massing model based on a wall 202 in the design model. In one implementation, a mass object created based on one or more design object faces has at least one surface that has the same or similar geometry as the face(s). For example, the mass object 112 has a surface 104 that has the same geometry as the wall 202 on which it is based. In another implementation, a mass object created from one or more detailed object faces has at least one surface that is related proportionally to the face(s).

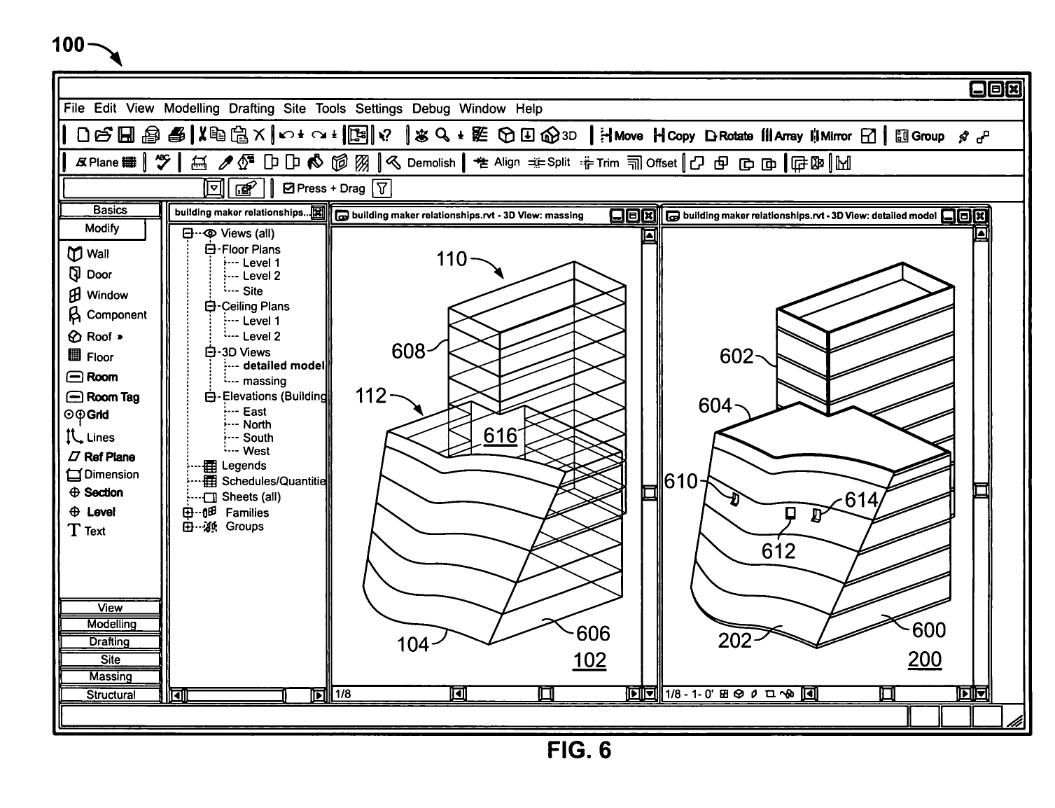

By way of further illustration and with reference to FIG. 6, a mass object's geometry can be incrementally developed through the addition of faces. For example, mass object 112 has three faces derived from detailed object faces in the design model. Mass object face 606 is based on wall 600 and mass object face 616 is based on roof 604. In one implementation, a mass object's geometry can be completed automatically to create a 3D mass object form if three or two faces are provided. The later case assumes that at least one of the faces is adjacent to, or interfaces with, another mass object's face. In one implementation, a single mass object face can be created from a single detailed object face. Alternatively, a separate mass object face can be created two or more selected detailed object faces. In yet a further alternative, multiple mass object faces can be created in the mass model based on a single detailed object face.

In one implementation, a mass object created based on one or more detailed object faces has at least one face that has the same or similar geometry as the detailed object face(s). For example, a mass object face can have the same geometry as the wall face on which it is based. In another implementation, a mass object created from one or more design object faces has at least one surface that is related proportionally to the design object face(s). For example, a mass object face may be larger than a floor face in the detailed model since the floor may be set back an equal distance from interior walls, even though it has the same general shape as the face representing the floor on which it is based. In yet a further implementation, an automatically created mass object's geometry is determined by rules or attributes associated with the system or the detailed object.

An automatically created object in either model has a face at a location corresponding to the location of the face or faces it was created from in the other model. In another implementation, an automatically created object in either model has a face that is offset from the corresponding face in the other model. For example, a wall may need to be offset from the mass object face to accommodate for the wall thickness. In yet a further implementation, an object's location in a model is determined by rules or attributes associated with the object or the system.

In one implementation, an object in either model can be created from one or more features of an object in the other model, not merely faces. For example, mass objects can include features such as, but not limited to, volume, skin properties, load, metadata, orientation towards a light source, relationship to other mass objects, and other suitable features. Likewise, detailed objects include features such as, but not limited to, materials, components, heat transfer properties, annotations, metadata, and other suitable features. Rules can be used to automatically create objects by identifying features or combinations of attributes that yield objects in one model based on objects in the other model.

Alternatively, objects can be created automatically in either model without requiring user interaction. In one implementation, this can be accomplished using rules or heuristics. For example, if a surface is regarded as being more vertical than horizontal, the surface can be considered a wall rather than a roof. In yet a further alternative, the system can learn based on user selections which features of a given object in a given model can be used to create objects in the other model.

An association is established between automatically created objects and the objects which they are based on. In another implementation, an association is established between a feature of an automatically created object and the feature of the object on which it is based. The association allows changes to be propagated between the objects. In one implementation, changes to the geometry or location of face(s) of an object in one model cause the corresponding object in the other model to be updated. By way of illustration, detailed objects such as the wall 202 can be updated automatically when features of the mass object(s) they are associated with changed. For example, if the size or location of a mass object's face changes, the associated detailed object(s) that depend on the face can be modified to reflect the change (e.g., they can be moved or geometrically reconstructed to match the face). Changes can be propagated immediately or under user control. The later approach allows a user to work without having to be concerned about what affect an action in one model will have in the other.

Some changes to features in one model's object(s) can create conflicts when attempting to propagate the changes to the other model's object(s). For example and with reference to FIG. 2, if the wall 202 geometry is changed by the user or if the wall 202 is moved from its original location in the detailed model, the wall will no longer correspond to the face 104 in the massing model. If a user then modifies the geometry of face 104, propagating the changes to the wall 202 will result in the user's earlier changes to the wall 202 being lost. In another implementation, changes an object can take precedent such that any changes propagating from another object will not be applied. In yet a further implementation, the user can be notified of the conflict and given the opportunity to choose how the conflict should be resolved. Alternatively, the user can define rules which dictate how conflicts between object features should be resolved.

Propagation of changes between models is based on associations between objects. In one embodiment, associations can be represented by metadata associated with one or more of the objects. The metadata can refer to an object or object feature by an object name or other identifier. Alternatively, the associations can be represented as a directed graph between the objects or features. This disclosure is not limited to any particular type of association mechanism. Many other means of associating objects/features, although not explicitly discussed, are fully within the scope and spirit of this disclosure.

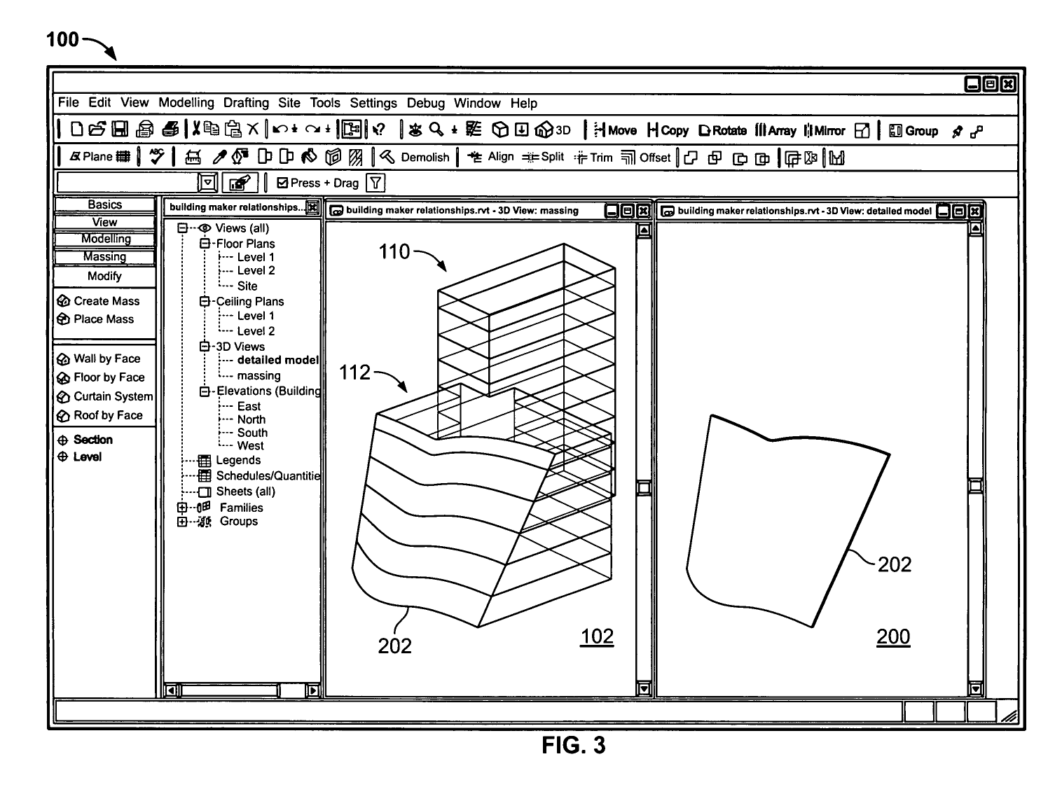

FIG. 3 is screen shot of the GUI 100 illustrating a newly created detailed object 202 in the massing model and the detailed model. In one implementation, both models are filtered views of a common underlying model. Thus, it is possible to present objects from both models in the same logical model, as is shown in GUI region 102.

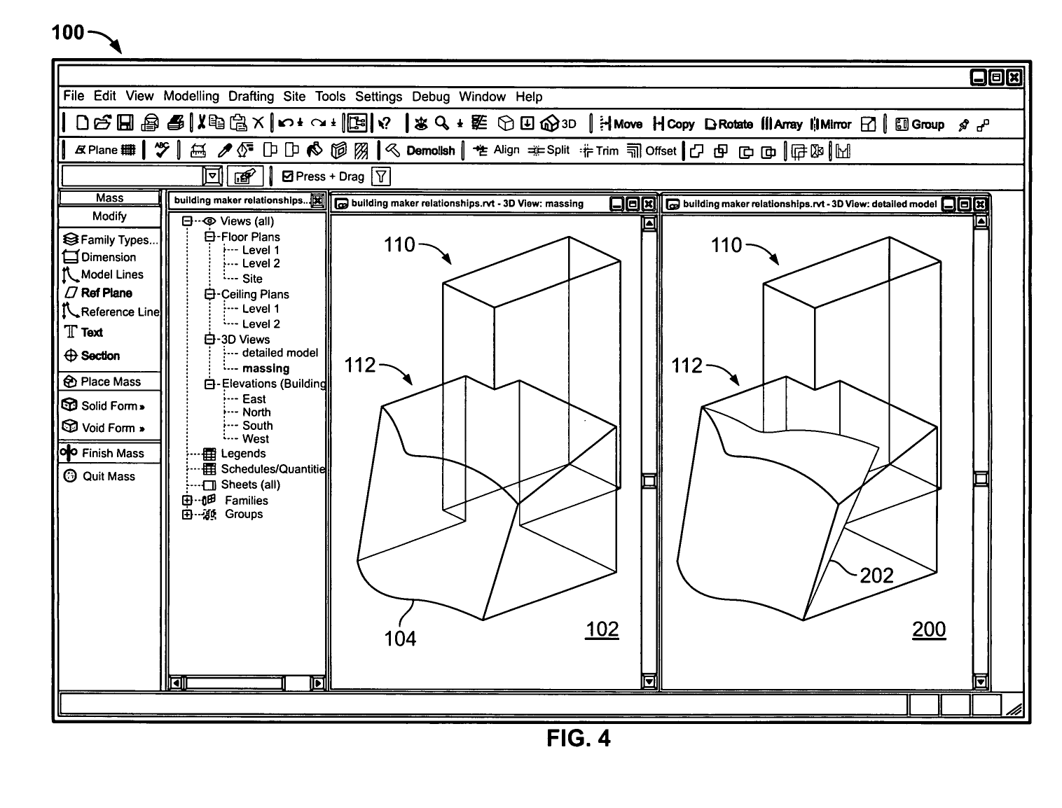

FIG. 4 is a screen shot of the GUI 100 after the shape of a mass object 112 face has changed. In GUI region 102, a view of the modified massing model is presented. Face 104 of mass object 104 has been modified from its original geometry (as shown in FIG. 1). In GUI region 200, a view of both the massing model and the detailed model is presented. However, the wall 202 has the original geometry of the face 104.

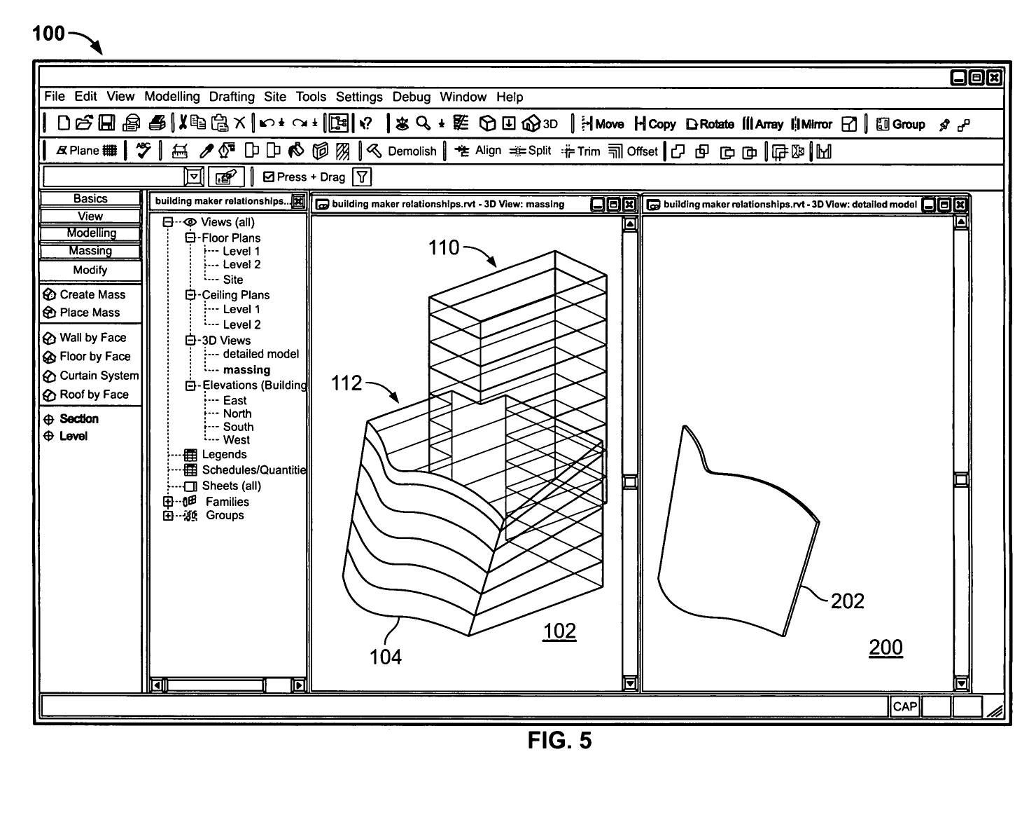

FIG. 5 is a screen shot of the GUI 100 showing wall 202 after being updated with the face's 104 new geometry. In one implementation, detailed objects such as the wall 202 can be updated automatically when features of the mass object(s) they are associated with changed. For example, if the size or location of a mass object faces changes, the associated detailed object(s) that depend on the face can be modified to reflect the change (e.g., they can be moved or reconstructed to match the face). But since mass objects can be flexed by a user loosely and dynamically, one implementation does not automatically update associated detailed objects since doing so could potentially disrupt the detailed model. This implementation requires the user to manually trigger the update process.

FIG. 6 is a screen shot of the GUI 100 showing both the massing model and the detailed model after additional detailed objects are added to the detailed model. The detailed model shown in GUI region 200 now includes two new exterior walls (600, 602), a roof 604, and windows (610, 612 and 614) placed in wall 202. In this illustration, the wall 600 was created from face 606 in the massing model shown in GUI region 102. Likewise, wall 602 and roof 604 were created based on face 608 and face 616, respectively. In one implementation, other detailed objects that have no analog in the massing model can be added to the detailed model. For example, windows 610, 612 and 614 are not associated with any object in the massing model. However, because these windows are associated with the generated wall 202, their position may change if that wall configuration is changed.

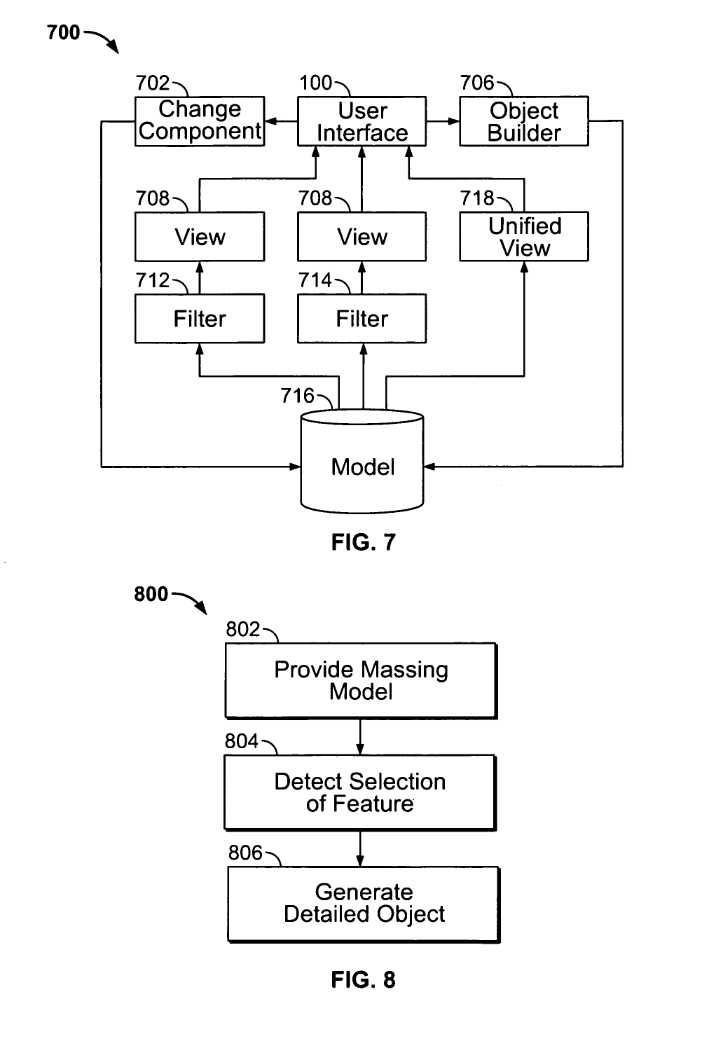

FIG. 7 is a diagram illustrating system 700. As discussed above, the user interface 100 can present views of models to the user which can be manipulated and modified by the user. In one implementation, the massing and detailed models are views of a common model 716. For example, objects represented in the massing and detailed models can be part of the same model, although the objects can be presented to the user (e.g., in views) as being in separate, logical models. In another implementation, the massing and detailed models are separate models that are logically part of the common model 716.

In one implementation, the object model 716 can maintain hierarchical relationships between objects based on containment or other properties of the objects. For example, if a wall has a window, the window would be “contained” in the wall. Thus, the child window's parent is the wall. In one implementation, the common model 716 is represented by one or more directed graphs that embody various relationships between objects. In another implementation, the common model 716 is implemented as an object-oriented database. The model 716 model can be persisted in one or more files or other suitable storage. In one implementation, the model 716 is persisted in a single file.

In one implementation, an object can inherit attributes and behaviors from one or more types. In one implementation, types can inherit attributes and behaviors from other types. For example, a “exterior wall” object can inherit from a general “wall” type. In one implementation, if an attribute or behavior of a type is modified, all types and objects that inherit from that type will reflect the change. An attribute is a property that can be read and/or modified by an object or other entity. By way of illustration, object attributes can be used to identify other associated objects. A behavior is a method or function that can be invoked by an object or other entity. For example, a “construct” behavior can utilize geometric primitives to build the object's geometry based on a 2D profile sketch (e.g., using techniques such as extrusion, sweeping, connecting or blending).

An object builder component 706 creates new objects in either model based on attributes or features (e.g., faces) of other object(s) in the other model, and establishes associations between objects/features to represent these dependencies. The object builder 706 instantiates an object of the appropriate type and constructs the object using the geometry (or other feature) of the other object(s). The object builder 706 can be invoked manually by the user from GUI 100 through selection of one or more object features. Alternatively, the object builder 706 can be invoked automatically in which case rules or heuristics can be used to determine how features/objects in one model map to features/objects in the other model.

A change component 702 is responsible for propagating changes to objects when objects/features they depend on change. By way of illustration, if a mass object's face geometry is modified, the corresponding detailed object's geometry will be changed to match the new geometry of the face. In another implementation, change propagation can be implemented in an automatic fashion, so that when a user changes an object, dependent objects are automatically updated. Alternatively, the change component 702 can be invoked manually by the user after the user has made their modifications to one model or the other. In one implementation, the change component 702 can propagate changes in the model 716 by traversing associations between objects in the model and modifying affected objects. In doing so, the change component 702 can encounter conflicts that arise when attempting to apply a change to an object as discussed above. The change component 702 can resolve such conflicts using rules or, alternatively, by allowing the user to resolve the conflict.

One or more view components 708 provide views of model(s) to the GUI 100. A view is an nD (e.g., 2D or 3D) presentation of one or more models. A user can interact with a view 708 through a display region of the GUI 100. Views allow a user to interactively navigate and modify the model(s) presented therein. When a view presents more than one model, the models can be visually integrated or presented in separate panes within the view. A view 708 can utilize a model filter component (712, 714) to optionally filter out objects and other information from the model that are not of interest. For example, filter 712 can remove detailed objects so that a view only “sees” mass objects. Likewise, filter 714 can remove mass objects so that a view only “sees” detailed objects. A unified view 718 has no filter and thus presents all the objects in the model. Changes made to the model by the change component 702 or the object builder 706 are potentially reflected in all views (708, 718) assuming the changes are not filtered out.

FIG. 8 is a flow diagram 800 illustrating creation of a detailed object from a feature of a mass object. A massing model including one or more mass objects is created by a user or imported from a CAD tool (step 802). The massing model can presented to the user in a GUI (e.g., user interface 100). Selection of a feature of a mass object in the massing model is detected (step 804). For example, a face on the mass object can be selected with a mouse or through another input device. A detailed object is created in a detailed model based on the feature (step 806).

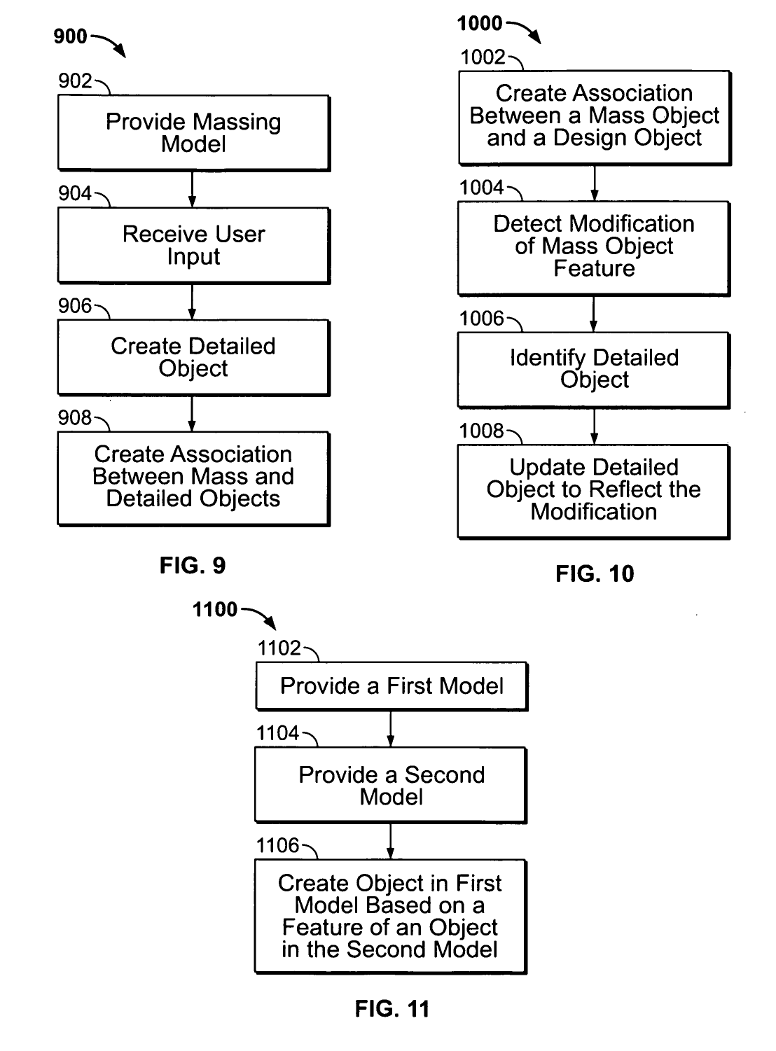

FIG. 9 is a flow diagram 900 illustrating creation of an association between objects. A massing model including one or more mass objects is created by a user or imported from a CAD tool (step 902). User input is received selecting a mass object in the massing model (step 904). A detailed object is automatically created in a detailed model (step 906). The detailed object based on the selected mass object. An association is created between the detailed object and the selected mass object such that changes to the mass object can be propagated to the detailed object (step 908).

FIG. 10 is a flow diagram 1000 illustrating change propagation. An association is created between a feature of a mass object in a massing model and a detailed object in a detailed model (step 1002). A modification of a feature of the mass object is detected (step 1004). The detailed object is identified based on the association (step 1006). The detailed object to updated to reflect the modification of the feature (step 1006).

FIG. 11 is a flow diagram 1100 illustrating automatic conversion of a model. A first model is provided, first model being one of: a massing model or a detailed model (step 1102). A second model is provided, the second model being the other one of the massing CAD model or the detailed CAD model (step 1104). A first object in the first model is created based on a feature of a second object in the second model (step 1106).

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine readable storage device, medium, or in a propagated signal, for execution by, or to control the operation of, data processing apparatus, e.g., a programmable processor, a computer, or multiple computers.

A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; a magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

A number of implementation of the invention have been described. Nevertheless, it will be understood that various modifications may be made without departing from the spirit and scope of the invention. Accordingly, other implementations are within the scope of the following claims.

What is claimed is:

1. A computer-implemented method, comprising:
providing a massing computer aided design (CAD) model;
receiving a user input selecting a feature of a mass object in the massing CAD model; and
creating a detailed object in a detailed CAD model, the detailed object based on the selected feature.

2. The method of claim 1, where:
providing the massing CAD model includes receiving user input creating the massing CAD model.

3. The method of claim 1, where:
providing the massing CAD model includes importing the massing CAD model.

4. The method of claim 1, further comprising:
providing an interactive view of one or more of the massing CAD model or the detailed CAD model.

5. The method of claim 1, where:
the detailed object is one of: a curtain system, a wall, a floor, or a roof, or a building construction element.

6. The method of claim 1, where:
the mass object is a geometric form of a building or a geometric form of a portion of a building.

7. The method of claim 1, where:
the massing CAD model and the detailed CAD model are versions of a common CAD model.

8. The method of claim 1, where:
the selected feature is a surface on the mass object.

9. The method of claim 1, where:
the user input designates a detailed object type.

10. The method of claim 1, where:
creating the detailed object includes creating a surface on the detailed object that is equivalent to, or proportional to, a surface on the mass object.

11. The method of claim 1, where:
creating the detailed object includes creating the detailed object at a location in the detailed model that corresponds to a location in the massing model.

12. The method of claim 1, further comprising:
modifying geometry of the selected mass object based on user input; and
updating geometry of the detailed object to reflect the modifying of the selected mass object.

13. A computer-implemented method, comprising:
providing a massing computer aided design (CAD) model;
receiving a user input selecting a mass object in the massing CAD model;
creating a detailed object in a detailed CAD model, the detailed object based on the selected mass object; and
creating an association between the detailed object and the selected mass object such that changes to the mass object can be propagated to the detailed object.

14. The method of claim 13, where:
creating an association includes associating a surface on the selected mass object with the detailed object.

15. The method of claim 13, further comprising:
modifying geometry of the selected mass object based on user input; and
updating geometry of the detailed object to reflect the modifying of the selected mass object.

16. The method of claim 15, where:
updating geometry of the detailed object includes conforming geometry of the detailed object to a modified surface of the selected mass object.

17. The method of claim 13, further comprising:
modifying geometry of the detailed object based on user input; and
updating geometry of the selected mass object to reflect the modifying of the detailed object.

18. The method of claim 17, where:
updating geometry of the selected mass object includes conforming geometry of a surface on the selected mass object to geometry of the detailed object.

19. A computer-implemented method, comprising:
selecting a feature of a mass object in a massing computer aided design (CAD) model; and
creating a detailed object in a detailed CAD model, the detailed object based on the selected feature.

20. The method of claim 19, where:
the feature is a surface on the mass object.

21. The method of claim 19, where:
creating a detailed object creates an association between the feature and the detailed object such that changes to the feature can be propagated to the detailed object.

22. The method of claim 19, where:
the massing CAD model is a massing study of a building, building complex or structure.

23. The method of claim 19, where:
the detailed CAD model is a building design.

24. A computer-implemented method, comprising:
creating an association between a feature of a mass object in a massing computer aided design (CAD) model and a detailed object in a detailed CAD model;
detecting modification of a feature of the mass object;
identifying the detailed object based on the association; and
updating the detailed object to reflect the modification of the feature.

25. The method of claim 24, where:
the feature is a surface.

26. The method of claim 25, where:
updating the detailed object includes incorporating the geometry of the surface into the detailed object.

27. The method of claim 24, further comprising:
determining whether updating the detailed object would create a conflict.

28. The method of claim 27, further comprising:
resolving the conflict.

29. The method of claim 24, further comprising:
detecting modification of the detailed object;
identifying the mass object based on the association; and
updating the mass object to reflect the modification of the detailed object.

30. A computer-implemented method, comprising:
providing a first model, the first model being one of: a massing computer aided design (CAD) model or a detailed CAD model;
providing a second model, the second model being an other one of: the massing CAD model or the detailed CAD model; and
creating a first object in the first model based on a feature of the a second object in the second model.

31. The method of claim 30, where:
providing the first model includes receiving user input creating the first model; and
providing the second model includes receiving user input creating the second model.

32. The method of claim 30, where:
providing the first model includes importing the first model; and
providing the second model includes importing the second model.

33. The method of claim 30, where:
an object is one of: a mass object, a curtain system, a wall, a floor, or a roof, or a building construction element.

34. The method of claim 33, where:
a mass object is a geometric form of a building or a geometric form of a portion of a building.

35. The method of claim 30, where:
the massing CAD model and the detailed CAD model are versions of a common CAD model.

36. The method of claim 30, where:
creating the first object includes creating a surface on the first object that is equivalent to, or proportional to, a surface on the second object.

37. The method of claim 30, where:
creating the first object includes creating the first object at a location in the first model that corresponds to a location in the second model.

38. The method of claim 30, where:
the first object and the second object have one or more equivalent surface geometries.

39. A computer program product, encoded on an information carrier, comprising instructions operable to cause a data processing apparatus to perform:
providing a massing computer aided design (CAD) model;
receiving a user input selecting a feature of a mass object in the massing CAD model; and
creating a detailed object in a detailed CAD model, the detailed object based on the selected feature.

40. A computer program product, encoded on an information carrier, comprising instructions operable to cause a data processing apparatus to perform:
providing a massing computer aided design (CAD) model;
receiving a user input selecting a mass object in the massing CAD model;
creating a detailed object in a detailed CAD model, the detailed object based on the selected mass object; and
creating an association between the detailed object and the selected mass object such that changes to the mass object can be propagated to the detailed object.

41. A computer program product, encoded on an information carrier, comprising instructions operable to cause a data processing apparatus to perform:
selecting a feature of a mass object in a massing computer aided design (CAD) model; and
creating a detailed object in a detailed CAD model, the detailed object based on the selected feature.

42. A computer program product, encoded on an information carrier, comprising instructions operable to cause a data processing apparatus to perform:
creating an association between a feature of a mass object in a massing computer aided design (CAD) model and a detailed object in a detailed CAD model;
detecting modification of a feature of the mass object;
identifying the detailed object based on the association; and
updating the detailed object to reflect the modification of the feature.

43. A computer program product, encoded on an information carrier, comprising instructions operable to cause a data processing apparatus to perform:
providing a first model, the first model being one of: a massing computer aided design (CAD) model or a detailed CAD model;
providing a second model, the second model being an other one of: the massing CAD model or the detailed CAD model; and
creating a first object in the first model based on a feature of the a second object in the second model.
